(19) United States
(12) Patent Application Publication
(10) Pub. No.: US 2026/0196564 A1
(43) Pub. Date: Jul. 9, 2026

(54) TEMPERATURE STABLE LIQUID ELECTROLYTE FOR BATTERY CELL

(71) Applicant: Rivian IP Holdings, LLC, Irvine, CA (US)

(72) Inventors: Judith Alvarado KIM, San Leandro, CA (US); Huaxin GONG, Fremont, CA (US); Woochul SHIN, Fremont, CA (US); Yumi KIM, San Jose, CA (US); Saravanan KUPPAN, San Jose, CA (US); Cary Michael HAYNER, Half Moon Bay, CA (US); Soo KIM, Fremont, CA (US)

(21) Appl. No.: 19/285,970

(22) Filed: Jul. 30, 2025

Related U.S. Application Data
(60) Provisional application No. 63/743,138, filed on Jan. 8, 2025.

(51) Int. Cl. H01M 10/0569; B60L 50/64; H01M 10/0525; H01M 10/0567; H01M 10/0568

(52) U.S. Cl. CPC H01M 10/0569; H01M 10/0525; H01M 10/0567; H01M 10/0568; B60L 50/64; H01M 2220/20; H01M 2300/004

(57) ABSTRACT

Aspects of the disclosure relate to an electrolyte for a battery cell such as a rechargeable battery cell and includes (i) a lithium salt; (ii) a low temperature solvent combination in a ratio of from about 1:1.25 to about 1.4; optionally (iii) an additive of butane sultone (BS) in an amount from about 0.1 wt % to about 1.5 wt %, e.g., 1 wt %, based on a total weight of the electrolyte; and optionally (iv) an additional additive of ethylene sulfite (ES), hexane tricarbonitrile (HTCN), fluoroethylene carbonate (FEC), vinylene carbonate (VC), lithium difluorophosphate, or a combination of two or more thereof.

### CROSS REFERENCE TO RELATED APPLICATIONS

This application claims the benefit of priority to U.S. Provisional Patent Application No. 63/743,138, entitled “TEMPERATURE STABLE LIQUID ELECTROLYTE FOR BATTERY CELL”, filed on Jan. 8, 2025, the disclosure of which is hereby incorporated herein in its entirety.

### INTRODUCTION

The present disclosure generally relates to an electrolyte for use in battery cells such as high energy lithium battery cells. Battery cells are often used to store and discharge electrical energy.

Aspects of the subject technology can help improve the operation and implementation of battery cells. For example, battery cells having an electrolyte of the present disclosure can improve the stability of high energy battery cells, reduce costs, and increase utilization of such batteries. Batteries with increased energy density and lower costs can help to mitigate climate change by reducing and/or preventing additional greenhouse gas emissions.

### SUMMARY

The present disclosure generally relates to an electrolyte for use in battery cells. The electrolyte includes (i) a lithium salt or a combination of lithium salts; and (ii) a low temperature solvent combination in a ratio of about 1:1.25 to about 1:4 of: (a) ethylene carbonate to (b) a low temperature solvent selected from dimethyl carbonate (DMC), ethyl methyl carbonate (EMC), methyl acetate (MA), ethyl propionate (EP), or a combination thereof. In an aspect, the low temperature solvent is a combination of (a) ethylene carbonate to (b) dimethyl carbonate (DMC) in a ratios of from about 1:1.25 to about 1:1.75 or about 1:3 to about 1:3.6. Advantageously, the lithium salt can include or consists of: lithium hexafluorophosphate (LiPF₆) in an amount of from about 1 Molar (M) to about 3 M and lithium bis(fluorosulfonyl)imide (LiFSI) in an amount of from about 0.1 M to about 1 M. Additionally, electrolytes of the present disclosure can include (iii) an additive of butane sultone (BS) in an amount from about 0.1 wt % to about 1.5 wt %, e.g., 1 wt %, based on a total weight of the electrolyte.

In some implementations, the electrolyte can further include (iv) an additional additive of ethylene sulfite (ES), hexane tricarbonitrile (HTCN), fluoroethylene carbonate (FEC), vinylene carbonate (VC), or a combination of two or more thereof. The total weight of additional additives can be included in the electrolyte in an amount of up to 8 wt % based on a total weight of the electrolyte. In an aspect, the electrolyte can include each of the additional additives and in an amount independently up to about 3 wt % based on a total weight of the electrolyte.

In accordance with one or more other implementations, a battery cell includes the electrolyte of the present disclosure. For example, the battery cell can include an electrolyte having (i) one or more lithium salts; (ii) a low temperature solvent combination in a ratio of from about 1:1.25 to about 1:4; optionally (iii) an additive of butane sultone (BS) in an amount from about 0.1 wt % to about 1.5 wt %, e.g., 1 wt %, based on a total weight of the electrolyte; and optionally (iv) an additional additive of ethylene sulfite (ES), hexane tricarbonitrile (HTCN), fluoroethylene carbonate (FEC), vinylene carbonate (VC), lithium difluorophosphate, or a combination of two or more thereof.

The battery can further include a negative and positive electrode. The negative electrode can include an anode active material on a current collector and/or can include a current collector and lithium metal formed thereon in-situ. The positive electrode can include a cathode active material including a lithium metal oxide, a lithium metal phosphate, lithium spinel, or a combination thereof. Further, the battery cell can be configured to have a salt decomposition voltage of no more than 1.45 V, such as less than 1.4V or lower, e.g., the electrolyte sale decomposes, at least in part, at 1.4V or less.

In one or more implementations, a battery cell having an electrolyte as described herein can be included in a building and/or movable apparatus, e.g., a vehicle. For example, such a battery cell can be configured to power one or more components or systems of a building and/or a vehicle.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle having a battery pack in accordance with one or more implementations.

FIG. 1C illustrates a schematic perspective view of a building having a battery pack in accordance with one or more implementations.

FIG. 2A illustrates a schematic perspective view of a battery pack in accordance with one or more implementations.

FIG. 2B illustrates schematic perspective views of various battery modules that may be included in a battery pack in accordance with one or more implementations.

FIG. 2C illustrates a cross-sectional end view of a battery cell in accordance with one or more implementations.

FIG. 2D illustrates a cross-sectional perspective view of a cylindrical battery cell in accordance with one or more implementations.

FIG. 2E illustrates a cross-sectional perspective view of a prismatic battery cell in accordance with one or more implementations.

FIG. 2F illustrates a cross-sectional perspective view of a pouch battery cell in accordance with one or more implementations.

FIG. 3 illustrates a chart of Retention (%) vs discharge rates (C/10, C/3, C/2) at a temperature of −20° C. The data was collected from a single layer pouch cell with a Ni 94 cathode and AG:NG:SiOx (Artificial Graphite: Natural Graphite: Silicon Oxide) anode.

FIG. 4A and FIG. 4B illustrate charts of Discharge Capacity at various discharge rates at a temperature of 0° C. comparing sample C1 to R1. The data was collected from a single layer pouch cell with a Ni 94 cathode and AG:NG:SiOx anode.

FIG. 5A and FIG. 5B illustrate charts of Direct Current Internal Resistance (DCIR) at various temperatures comparing sample C1 to R1. The data was collected from a single layer pouch cell with a Ni 94 cathode and AG:NG:SiOx anode, and 50% state of charge.

FIG. 6 illustrates a chart showing electrolyte decomposition with respect to cell voltage. The data was collected from a single layer pouch cell with a Ni 94 cathode and AG:NG:SiOx anode. when the electrolyte tests in the various samples has some decomposition of their components.

FIG. 7 illustrates a chart of Direct Current Internal Resistance (DCIR) at various state of charge (SOC) states of a battery cell comparing electrolyte samples C2 and R3 at room temperature.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

As discussed in further detail hereinafter, a battery cell composed of an electrolyte of the present disclosure may be used to store and discharge electrical energy. A battery cell of the present disclosure can be used alone or multiple battery cells can be assembled or packaged together in the same housing, frame, or casing to form a battery subassembly, module and/or battery pack. Further, multiple battery subassemblies or modules can be assembled or packaged together to form a battery pack. The battery cells of a battery subassembly, module and/or pack can be electrically connected to generate a desired voltage output for the battery subassembly, module and/or pack. The battery subassembly, module and/or pack in turn can be electrically connected to a power-consuming component, such as a vehicle and/or an electrical system of a building.

### Vehicles, Battery Packs, Cells

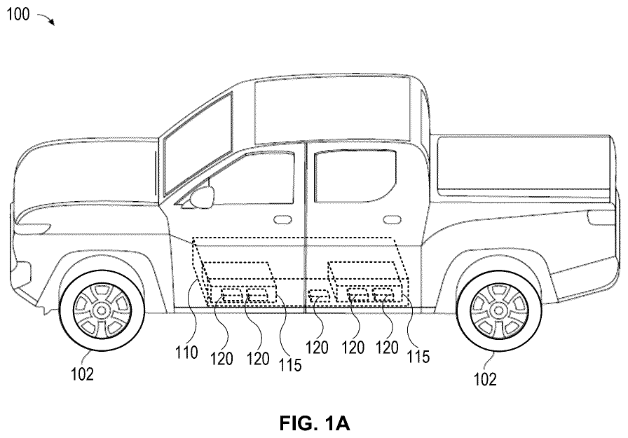

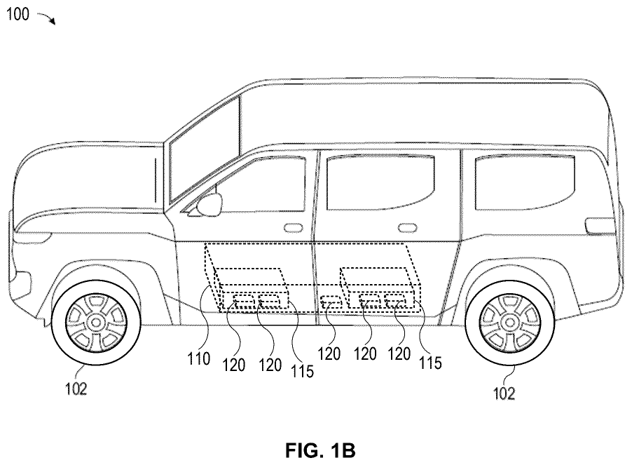

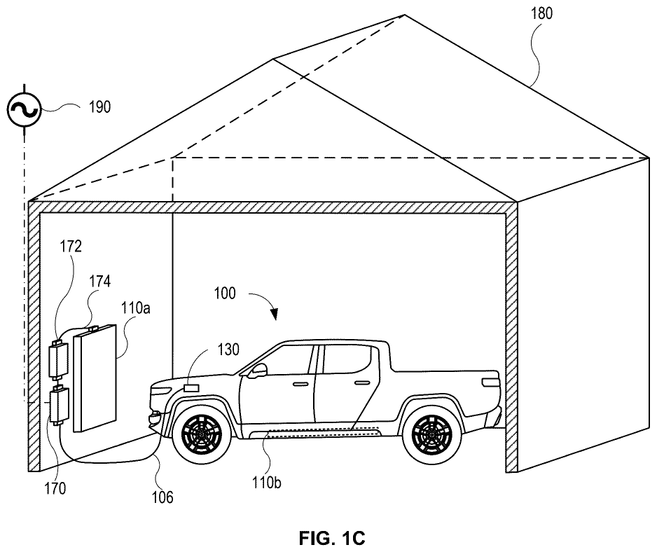

FIG. 1A is a diagram illustrating an example implementation of a movable apparatus as described herein. In the example of FIG. 1A, a movable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle using electric power from the battery pack 110. In one or more implementations, the vehicle 100 may also, or alternatively, include one or more chemically-powered engines, such as a gas-powered engine or a fuel cell powered motor. For example, electric vehicles can be fully electric or partially electric (e.g., hybrid or plug-in hybrid). In various implementations, the vehicle 100 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIG. 1A, the vehicle 100 is implemented as a truck (e.g., a pickup truck) having a battery pack 110. As shown, the battery pack 110 may include one or more battery subassemblies (e.g., modules) 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without any battery modules 115 and with the battery cells 120 mounted directly in the battery pack 110 (e.g., in a cell-to-pack configuration) and/or in other battery units that are installed in the battery pack 110. A vehicle battery pack can include multiple energy storage devices that can be arranged into such as battery modules or battery units. A battery unit (e.g., a subassembly or module) can include an assembly of cells that can be combined with other elements (e.g., structural frame, thermal management devices) that can protect the assembly of cells from heat, shock and/or vibrations.

For example, the battery cell 120 can be included a battery, a battery unit, a battery subassembly, module and/or a battery pack to power components of the vehicle 100. For example, a battery cell housing of the battery cell 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle and/or the motor(s) that drive the wheels 102 of the vehicle). The power stage circuit can be provided as part of the battery pack 110 or separately from the battery pack 110 within the vehicle 100.

The example of FIG. 1A in which the vehicle 100 is implemented as a pickup truck having a truck bed at the rear portion thereof is merely illustrative. For example, FIG. 1B illustrates another implementation in which the vehicle 100 including the battery pack 110 is implemented as a sport utility vehicle (SUV), such as an electric sport utility vehicle. In the example of FIG. 1B, the vehicle 100 including the battery pack 110 may include a cargo storage area that is enclosed within the vehicle 100 (e.g., behind a row of seats within a cabin of the vehicle). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the movable apparatus).

In one or more implementations, a battery pack such as the battery pack 110, a battery module 115, a battery cell 120, and/or any other battery unit as described herein may also, or alternatively, be implemented as an electrical power supply and/or energy storage system in a building, such as a residential home or commercial building. For example, FIG. 1C illustrates an example in which a battery pack 110 is implemented in a building 180. For example, the building 180 may be a residential building, a commercial building, or any other building. As shown, in one or more implementations, a battery pack 110 may be mounted to a wall of the building 180.

As shown, the battery 110A that is installed in the building 180 may be couplable to the battery pack 110 in the vehicle 100, such as via: a cable/connector 106 that can be connected to the charging port 130 of the vehicle 100, electric vehicle supply equipment 170 (EVSE), a power stage circuit 172, and/or a cable/connector 174. For example, the cable/connector 106 may be coupled to the EVSE 170, which may be coupled to the battery 110A via the power stage circuit 172, and/or may be coupled to an external power source 190. In this way, either the external power source 190 or the battery 110A that is installed in the building 180 may be used as an external power source to charge the battery pack 110 in the vehicle 100 in some use cases. In some examples, the battery 110A that is installed in the building 180 may also, or alternatively, be coupled (e.g., via a cable/connector 174, the power stage circuit 172, and the EVSE 170) to the external power source 190. For example, the external power source 190 may be a solar power source, a wind power source, and/or an electrical grid of a city, town, or other geographic region (e.g., electrical grid that is powered by a remote power plant). During, for example, times when the battery pack 110 in the vehicle 100 is not coupled to the battery 110A that is installed in the building 180, the battery 110A that is installed in the building 180 can be coupled (e.g., using the power stage circuit 172 for the building 180) to the external power source 190 to charge up and store electrical energy. In some use cases, this stored electrical energy in the battery 110A that is installed in the building 180 can later be used to charge the battery pack 110 in the vehicle 100 (e.g., during times when solar power or wind power is not available, in the case of a regional or local power outage for the building 180, and/or during a period of high rates for access to the electrical grid).

In one or more implementations, the power stage circuit 172 may electrically couple the battery 110A that is installed in the building 180 to an electrical system of the building 180. For example, the power stage circuit 172 may convert DC power from the battery 110A into AC power for one or more loads in the building 180. For example, the battery 110A that is installed in the building 180 may be used to power one or more lights, lamps, appliances, fans, heaters, air conditioners, and/or any other electrical components or electrical loads in the building 180 (e.g., via one or more electrical outlets that are coupled to the battery 110A that is installed in the building 180). For example, the power stage circuit 172 may include control circuitry that is operable to switchably couple the battery 110A between the external power source 190 and one or more electrical outlets and/or other electrical loads in the electrical system of the building 180. In one or more implementations, the vehicle 100 may include a power stage circuit (not shown in FIG. 1C) that can be used to convert power received from the electric vehicle supply equipment 170 to DC power that is used to power/charge the battery pack 110 of the vehicle 100, and/or to convert DC power from the battery pack 110 into AC power for one or more electrical systems, components, and/or loads of the vehicle 100.

In one or more use cases, the battery 110A that is installed in the building 180 may be used as a source of electrical power for the building 180, such as during times when solar power or wind power is not available, in the case of a regional or local power outage for the building 180, and/or during a period of high rates for access to the electrical grid (as examples). In one or more other use cases, the battery pack 110 that is installed in the vehicle may be used to charge the battery 110A that is installed in the building 180 and/or to power the electrical system of the building 180 (e.g., in a use case in which the battery 110A that is installed in the building 180 is low on or out of stored energy and in which solar power or wind power is not available, a regional or local power outage occurs for the building 180, and/or a period of high rates for access to the electrical grid occurs (as examples)).

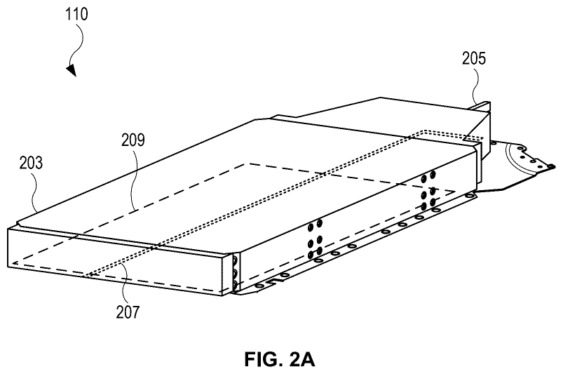

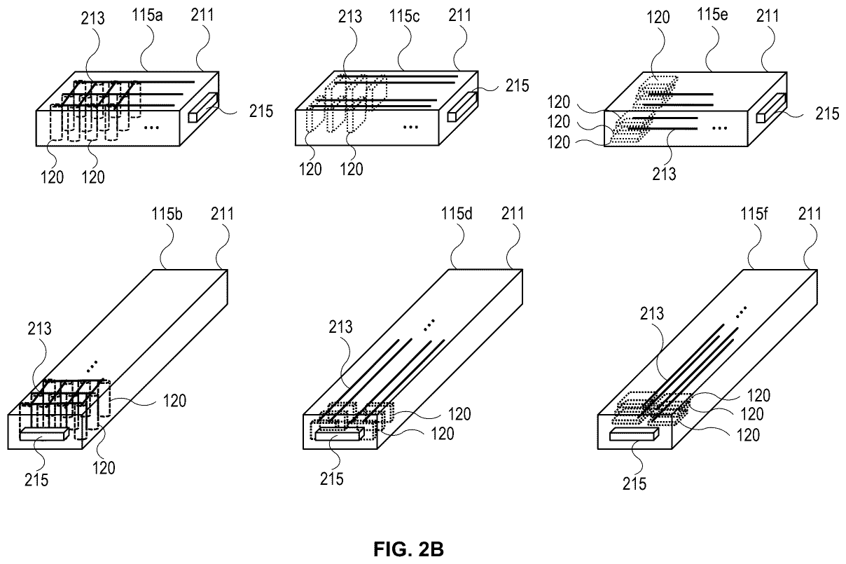

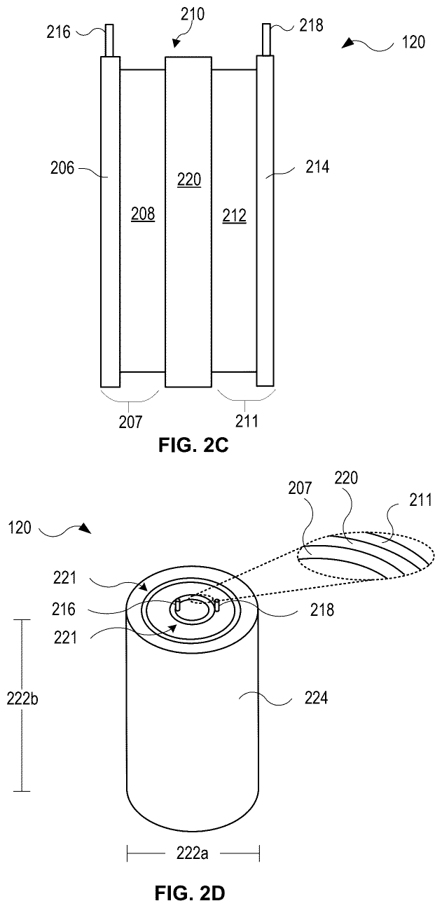

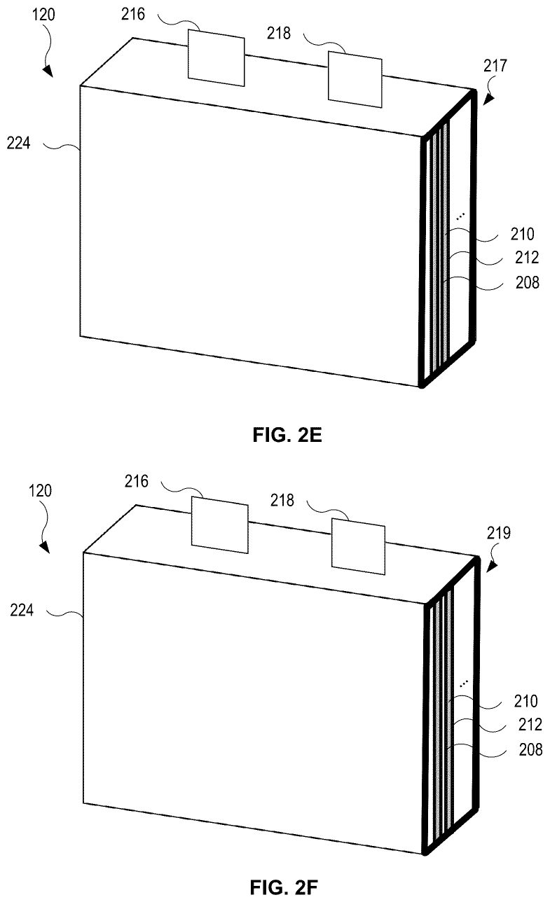

FIG. 2A depicts an example battery pack 110. Battery pack 110 may include multiple battery cells 120 (e.g., directly installed within the battery pack 110, or within batteries, battery units, and/or battery subassemblies) and/or battery modules 115, and one or more conductive coupling elements for coupling a voltage generated by the battery cells 120 to a power-consuming component, such as the vehicle 100 and/or an electrical system of a building 180. For example, the conductive coupling elements may include internal connectors and/or contactors that couple together multiple battery cells 120, battery units, batteries, and/or multiple battery modules 115 within the battery pack frame 205 to generate a desired output voltage for the battery pack 110. The battery pack 110 may also include one or more external connection ports, such as an electrical contact 203 (e.g., a high voltage terminal). For example, an electrical cable (e.g., cable/connector 106) may be connected between the electrical contact 203 and an electrical system of the vehicle 100 or the building 180, to provide electrical power to the vehicle 100 or the building 180.

As shown, the battery pack 110 may include a battery pack frame 205 (e.g., a battery pack housing or pack frame). For example, the battery pack frame 205 may house or enclose one or more battery modules 115 and/or one or more battery cells 120, and/or other battery pack components. In one or more implementations, the battery pack frame 205 may include or form a shielding structure on an outer surface thereof (e.g., a bottom thereof and/or underneath one or more battery module 115, battery units, batteries, and/or battery cells 120) to protect the battery module 115, battery units, batteries, and/or battery cells 120 from external conditions (e.g., if the battery pack 110 is installed in a vehicle 100 and the vehicle 100 is driven over rough terrain, such as off-road terrain, trenches, rocks, rivers, streams, etc.).

In one or more implementations, the battery pack 110 may include one or more thermal control structures 207 (e.g., cooling lines and/or plates and/or heating lines and/or plates). For example, thermal control structures 207 may couple thermal control structures and/or fluids to the battery modules 115, battery units, batteries, and/or battery cells 120 within the battery pack frame 205, such as by distributing fluid through the battery pack 110.

For example, the thermal control structures 207 may form a part of a thermal/temperature control or heat exchange system that includes one or more thermal components 215 such as plates or bladders that are disposed in thermal contact with one or more battery modules 115 and/or battery cells 120 disposed within the battery pack frame 205. For example, a thermal component 215 may be positioned in contact with one or more battery modules 115, battery units, batteries, and/or battery cells 120 within the battery pack frame 205. In one or more implementations, the battery pack 110 may include one or multiple thermal control structures 207 and/or other thermal components for each of several top and bottom battery module pairs. As shown, the battery pack 110 may include an electrical contact 203 (e.g., a high voltage connector) by which an external load (e.g., the vehicle 100 or an electrical system of the building 180) may be electrically coupled to the battery modules and/or battery cells in the battery pack 110.

FIG. 2B depicts various examples of battery subassemblies (e.g. modules 115) that may be disposed in the battery pack 110 (e.g., within the battery pack frame 205 of FIG. 2A). In the example of FIG. 2B, a battery module 115A is shown that includes a battery module housing 223 having a rectangular cuboid shape with a length that is substantially similar to its width. In this example, the battery module 115A includes multiple battery cells 120 implemented as cylindrical battery cells. In this example, the battery module 115A includes rows and columns of cylindrical battery cells that are coupled together by an interconnect structure 200 (e.g., a current connector assembly or CCA). For example, the interconnect structure 200 may couple together the positive terminals of the battery cells 120, and/or couple together the negative battery terminals of the battery cells 120. As shown, the battery module 115A may include a charge collector or bus bar 202. For example, the bus bar 202 may be electrically coupled to the interconnect structure 200 to collect the charge generated by the battery cells 120 to provide a high voltage output from the battery module 115A.

FIG. 2B also shows a battery module 115B having an elongated shape, in which the length of the battery module housing 223 (e.g., extending along a direction from a front end of the battery pack 110 to a rear end of the battery pack 110 when the battery module 115B is installed in the battery pack 110) is substantially greater than a width (e.g., in a transverse direction to the direction from the front end of the battery pack 110 to the rear end of the battery pack 110 when the battery module 115B is installed in the battery pack 110) of the battery module housing 223. For example, one or more battery modules 115B may span the entire front-to-back length of a battery pack within the battery pack frame 205. As shown, the battery module 115B may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115B.

In the implementations of battery module 115A and battery module 115B, the battery cells 120 are implemented as cylindrical battery cells. However, in other implementations, a battery module may include battery cells having other form factors, such as battery cells having a right prismatic outer shape (e.g., a prismatic cell), or a pouch cell implementation of a battery cell. As an example, FIG. 2B also shows a battery module 115C having a battery module housing 223 having a rectangular cuboid shape with a length that is substantially similar to its width and including multiple battery cells 120 implemented as prismatic battery cells. In this example, the battery module 115C includes rows and columns of prismatic battery cells that are coupled together by an interconnect structure 200 (e.g., a current collector assembly or CCA). For example, the interconnect structure 200 may couple together the positive terminals of the battery cells 120 and/or couple together the negative battery terminals of the battery cells 120. As shown, the battery module 115C may include a charge collector or bus bar 202. For example, the bus bar 202 may be electrically coupled to the interconnect structure 200 to collect the charge generated by the battery cells 120 to provide a high voltage output from the battery module 115C.

FIG. 2B also shows a battery module 115D including prismatic battery cells and having an elongate shape, in which the length of the battery module housing 223 (e.g., extending along a direction from a front end of the battery pack 110 to a rear end of the battery pack 110 when the battery module 115D is installed in the battery pack 110) is substantially greater than a width (e.g., in a transverse direction to the direction from the front end of the battery pack 110 to the rear end of the battery pack 110 when the battery module 115D is installed in the battery pack 110) of the battery module housing 223. For example, one or more battery modules 115D having prismatic battery cells may span the entire front-to-back length of a battery pack within the battery pack frame 205. As shown, the battery module 115D may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115D.

As another example, FIG. 2B also shows a battery module 115E having a battery module housing 223 having a rectangular cuboid shape with a length that is substantially similar to its width and including multiple battery cells 120 implemented as pouch battery cells. In this example, the battery module 115C includes rows and columns of pouch battery cells that are coupled together by an interconnect structure 200 (e.g., a current collector assembly or CCA). For example, the interconnect structure 200 may couple together the positive terminals of the battery cells 120 and couple together the negative battery terminals of the battery cells 120. As shown, the battery module 115E may include a charge collector or bus bar 202. For example, the bus bar 202 may be electrically coupled to the interconnect structure 200 to collect the charge generated by the battery cells 120 to provide a high voltage output from the battery module 115E.

FIG. 2B also shows a battery module 115F including pouch battery cells and having an elongate shape in which the length of the battery module housing 223 (e.g., extending along a direction from a front end of the battery pack 110 to a rear end of the battery pack 110 when the battery module 115E is installed in the battery pack 110) is substantially greater than a width (e.g., in a transverse direction to the direction from the front end of the battery pack 110 to the rear end of the battery pack 110 when the battery module 115E is installed in the battery pack 110) of the battery module housing 223. For example, one or more battery modules 115E having pouch battery cells may span the entire front-to-back length of a battery pack within the battery pack frame 205. As shown, the battery module 115E may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115E.

In various implementations, a battery pack 110 may be provided with one or more of any of the battery modules 115A, 115B, 115C, 115D, 115E, and 115F. In one or more other implementations, a battery pack 110 may be provided without battery modules 115 (e.g., in a cell-to-pack implementation).

In one or more implementations, multiple battery modules 115 in any of the implementations of FIG. 2B may be coupled (e.g., in series) to a current collector of the battery pack 110. In one or more implementations, the current collector may be coupled, via a high voltage harness, to one or more external connectors (e.g., electrical contact 203) on the battery pack 110. In one or more implementations, the battery pack 110 may be provided without any battery modules 115. For example, the battery pack 110 may have a cell-to-pack configuration in which battery cells 120 are arranged directly into the battery pack 110 without assembly into a battery module 115 (e.g., without including a separate battery module housing 223). For example, the battery pack 110 (e.g., the battery pack frame 205) may include or define a plurality of structures for positioning of the battery cells 120 directly within the battery pack frame 205.

FIG. 2C illustrates a cross-sectional end view of a portion of a battery cell 120. As shown in FIG. 2C, a battery cell 120 may include an anode 208, a cathode 212, a separator 220 therebetween to separate the anode 208 from the cathode 212, and an electrolyte 210 according to the present disclosure. As shown, the anode 208 may include or be electrically coupled to a first current collector 206 (e.g., a metal layer such as a layer of copper foil or other metal foil). As shown, the cathode 212 may include or be electrically coupled to a second current collector 214 (e.g., a metal layer such as a layer of aluminum foil or other metal foil). As shown, the battery cell 120 may include a first terminal 216 (e.g., a negative terminal) coupled to the anode 208 (e.g., via the first current collector 206) and a second terminal 218 (e.g., a positive terminal) coupled to the cathode (e.g., via the second current collector 214).

In one or more implementations, the battery cell 120 may be implemented as a lithium ion battery cell in which the anode 208 is formed from an intercalate material (e.g., graphite or silicon-carbon), or the battery cell 120 may be implemented as a lithium metal battery cell in which the anode 208 includes metallic lithium, or the battery cell 120 may be implemented as a hybrid battery cell in which the anode 208 includes a combination of intercalation material and a material that can promote lithium metal deposition. For example, anode 208 can be composed of a graphite or silicon-carbon. In these implementations, lithium ions can shuttle between the anode 208 and cathode 212 through electrolyte 210 during discharge and charge of the battery cell 120.

In other implementations, anode 208 can be formed on the first current collector 206 in situ during charging of the battery cell, e.g., an anode-free cell. In such an aspect, a negative electrode can include the current collector 206 (e.g., a metal foil such as a copper foil or carbon foil, or combinations thereof) with the in situ-formed anode, e.g., metallic lithium, on a surface of the current collector facing the separator 210. In such examples, a battery cell may be configured to lack an anode active material in an uncharged state.

In various implementations, the anode 208, the separator 220, the cathode 212, and electrolyte 210 of FIG. 2C can be packaged into a battery cell housing having any of various shapes, and/or sizes, and/or formed from any of various suitable materials. For example, battery cells 120 can have a cylindrical, rectangular, square, cubic, flat, pouch, elongated, or prismatic outer shape. As depicted in FIG. 2D, for example, a battery cell such as the battery cell 120 may be implemented as a cylindrical cell. In the example of FIG. 2D, the battery cell 120 includes a cell housing 224 having a cylindrical outer shape. For example, the anode 208, the separator 220, and the cathode 212 may be rolled into one or more substantially cylindrical windings 221. As shown, one or more windings 221 of the anode 208, the separator 220, and the cathode 212 may be disposed within the cell housing 224. In addition, separator layers may be disposed between adjacent windings 221. However, the cylindrical cell implementation of FIG. 2D is merely illustrative, and other implementations of the battery cells 120 are contemplated.

For example, FIG. 2E illustrates an example in which the battery cell 120 is implemented as a prismatic cell. As shown in FIG. 2E, the battery cell 120 may have a cell housing 224 having a right prismatic outer shape. As shown, one or more layers of the anode 208, the cathode 212, and the separator 220 disposed therebetween may be disposed within the cell housing 224 having the right prismatic shape. As examples, multiple layer of the anode 208, separator 220, and cathode 212 can be stacked (with an additional separator layer between adjacent stacks), or a single layer of the anode 208, separator 220, and cathode 212 can be formed into a flattened spiral shape and provided in the cell housing 224 having the right prismatic shape. In the implementation of FIG. 2E, the cell housing 224 has a relatively thick cross-sectional width 217 and is formed from a rigid material. For example, the cell housing 224 in the implementation of FIG. 2E may be formed from a welded, stamped, deep drawn, and/or impact extruded metal sheet, such as a welded, stamped, deep drawn, and/or impact extruded aluminum sheet. For example, the cross-sectional width 217 of the cell housing 224 of FIG. 2E may be as much as, or more than 1 millimeter (mm) to provide a rigid housing for the prismatic battery cell. In one or more implementations, the first terminal 216 and the second terminal 218 in the prismatic cell implementation of FIG. 2E may be formed from a feedthrough conductor that is insulated from the cell housing 224 (e.g., a glass to metal feedthrough) as the conductor passes through to cell housing 224 to expose the first terminal 216 and the second terminal 218 outside the cell housing 224 (e.g., for contact with an interconnect structure 200 of FIG. 2B). However, this implementation of FIG. 2E is also illustrative and yet other implementations of the battery cell 120 are contemplated.

For example, FIG. 2F illustrates an example in which the battery cell 120 is implemented as a pouch cell. As shown in FIG. 2F, one or more layers of the anode 208, the cathode 212, and the separator 220 disposed therebetween may be disposed (e.g., with an additional separator layers between the anode/separator/cathode layers) within the cell housing 224 that forms a flexible or malleable pouch housing. In the implementation of FIG. 2F, the cell housing 224 has a relatively thin cross-sectional width 219. For example, the cell housing 224 in the implementation of FIG. 2F may be formed from a flexible or malleable material (e.g., a foil, such as a metal foil, or film, such as an aluminum-coated plastic film). For example, the cross-sectional width 219 of the cell housing 224 of FIG. 2F may be as low as, or less than 0.1 mm, 0.05 mm, 0.02 mm, or 0.01 mm to provide flexible or malleable housing for the pouch battery cell. In one or more implementations, the first terminal 216 and the second terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 224 in these implementations. In the examples of FIGS. 2C, 2E, and 2F, the first terminal 216 and the second terminal 218 are formed on the same side (e.g., a top side) of the battery cell 120. However, this is merely illustrative and, in other implementations, the first terminal 216 and the second terminal 218 may formed on two different sides (e.g., opposing sides, such as a top side and a bottom side) of the battery cell 120. The first terminal 216 and the second terminal 218 may be formed on a same side or difference sides of the cylindrical cell of FIG. 2D in various implementations.

In one or more implementations, a battery module 115, a battery pack 110, a battery unit, or any other battery may include some battery cells 120 that are implemented with an electrolyte of the present disclosure. One or more of the battery cells 120 may be included in a battery module 115 or a battery pack 110, such as to provide an electrical power supply for components of the vehicle 100, the building 180, or any other electrically powered component or device. The cell housing 224 of the battery cell 120 can be disposed in the battery module 115, the battery pack 110, or installed in any of the vehicle 100, the building 180, or any other electrically powered component or device.

### Electrolyte

As discussed above, a battery cell (e.g., battery cell 120) including an electrolyte of the present disclosure can be used to store and discharge electrical energy and implemented in a building and/or movable apparatus. The electrolyte of the present disclosure can be used in lithium ion battery cells and battery cells that include lithium metal or a hybrid electrode.

Lithium-ion battery are engineered to build a robust solid electrolyte interphase (SEI) structures to passivate the anode and cathode in the battery cell. Such engineering should account for operating the cell at a wide temperature range including high temperatures, which can cause gassing and transition metal dissolution, and low temperatures, which can cause sluggish ion transport kinetics, high cell impedance, electrolyte freezing, etc.

Advantageously, electrolytes of the present disclosure can be used for lithium ion rechargeable batteries and can form protective solid-electrolyte interphases at the electrodes of such batteries at relatively low voltages to enhance operating temperature range and cycle life of the batteries. In some implementations, an electrolyte of the present disclosure can include (i) a lithium salt or combination of lithium salts; and (ii) a low temperature solvent combination to enhance low temperature performance (such as at or below −20° C.). Particularly useful solvent combinations were found to have a ratio of from about 1:1.25 to about 1:4 of: (a) ethylene carbonate to (b) dimethyl carbonate (DMC), ethyl methyl carbonate (EMC), methyl acetate (MA), ethyl propionate (EP), or a combination thereof. In an aspect, the low temperature solvent is a combination of (a) ethylene carbonate to (b) dimethyl carbonate (DMC) in a ratios of from about 1:1.25 to about 1:1.75 or about 1:3 to about 1:3.6, or from about 1:2.5 to about 1:4.

Electrolytes herein can be used for lithium ion rechargeable batteries and can perform at a wide operating temperature range. In some implementations, an electrolyte of the present disclosure can include (i) a lithium salt or combination of lithium salts; and (ii) EC to DMC ratio combination were found to have a ratio of from about 1:1.25 to about 1:1.75 and a ratio 1:3 to about 1:3.6 of: (a) ethylene carbonate (EMC) to (b) dimethyl carbonate (DMC).

In certain aspects, the lithium salt of the electrolyte of the present disclosure can include lithium bis(fluorosulfonyl)imide (LiFSI) and in an amount up to about 1.3 Molar (M), such as up to about 0.1 M, 0.2 M, 0.4M, 0.5 M, 0.8 M, 1 M, 1.3 M and any range thereof. For example, the lithium salt can include LiFSI in a range from about 0.1 M to about 1.3 M, e.g., from about 0.1 M, 0.2 M, 0.5 M, to about 0.8 M, 1 M or 1.3 M. In addition to LiFSI, the lithium salt of the electrolyte of the present disclosure can include the LiPF₆ in an amount of up to 3 M, such as up to about 0.1 M, 0.2 M, 0.5 M, 1 M, 1.3 M, 1.5 M, 2 M, 3 M and any range thereof. For example, the lithium salt can include the LiPF₆ in a range from about 0.1 M to about 3 M, e.g., from about 0.1 M, 0.5 M, 1 M to about 1.5 M, 2 M, or 3 M.

In addition, electrolytes of the present disclosure can include one or more of additives. It was found that including butane sultone (BS) in the electrolyte can enhance battery performance and in particular when combined with lithium bis(fluorosulfonyl)imide. In an aspect, the electrolyte of the present disclosure includes (iii) an additive of butane sultone (BS) in an amount up to about 1.5 wt %, based on a total weight of the electrolyte. For example, the electrolyte can include the butane sultone up to about 0.1 wt %, 0.2 wt %, 0.4 wt %, 0.5 wt %, 0.6 wt %, 0.8 wt %, 1 wt %, 1.5 wt %, and any range thereof such as from about 0.1 wt % to about 1.5 wt %, e.g., from about 0.1 wt %, 0.2 wt %, 0.3 wt % to about 0.7 wt %, 0.8 wt %, or 1 wt %, based on a total weight of the electrolyte.

It was further found that when the electrolyte of the present disclosure included an additional additive, a battery cell including such an electrolyte had better performance. In some implementations, the electrolyte can further include (iv) an additional additive of ethylene sulfite (ES), hexane tricarbonitrile (HTCN), fluoroethylene carbonate (FEC), vinylene carbonate (VC), or a combination of two or more thereof. In an aspect, the electrolyte includes each of the additional additives of ethylene sulfite (ES), hexane tricarbonitrile (HTCN), fluoroethylene carbonate (FEC), vinylene carbonate (VC). Further, the combination of components of the electrolyte of the present disclosure, can enhance cell power performance at various temperatures without sacrificing cycle life performance at high temperatures.

A total weight of additional additives in the electrolyte can be an amount of up to about 8 wt % based on a total weight of the electrolyte such as up to about 0.1 wt %, 0.5 wt %, 1 wt %, 1.5 wt %, 2 wt %, 2.5 wt %, 3 wt %, 4 wt %, 5 wt %, 6 wt %, 7 wt %, 8 wt %, and any range thereof such as from about 0.1 wt % to about 1.5 wt %, e.g., from about 0.5 wt %, 1 wt %, 1.5 wt % to about 3 wt %, 3.5 wt %, 4 wt %, 4.5 wt %, 5 wt %, 6 wt %, 7 wt %, 8 wt % based on a total weight of the electrolyte.

The total weight of additional additives can be included in the electrolyte in an amount of up to 8 wt % based on a total weight of the electrolyte. In an aspect, the electrolyte can include each of the additional additives and in an amount independently up to about 4 wt %, e.g., up to 2 wt %, based on a total weight of the electrolyte. For example, the electrolyte can include the additional additive in an amount of from about 0.1 wt % to about 4 wt % based on a total weight of the electrolyte.

Advantageously, the electrolyte of the present disclosure can limit the number and types of additives. For example, the electrolyte of the present disclosure can consist of butane sultone (BS) and one or more of the additional additives of ethylene sulfite (ES), hexane tricarbonitrile (HTCN), fluoroethylene carbonate (FEC), vinylene carbonate (VC), and lithium difluorophosphate. In addition, the electrolyte of the present disclosure can exclude other sultones such as excluding 1,3-propane sultone (PS), or prop-1-ene-1,3-sultone (PES).

The electrolyte of the present disclosure can be used in lithium ion battery cells and battery cells that include lithium metal.

Alternatively, the electrolyte of the present disclosure can be included in battery cells configured with an anode less or anode free negative electrode in which lithium and/or sodium metal is deposited during charging of the cell. For example, anodes that may be included in a battery cell in accordance with the present disclosure include an anode that may be formed in situ on a current collector, e.g., an anode-free cell. In such an aspect, a negative electrode can include a current collector (e.g., a metal foil such as a copper foil or carbon-coated foil) with the in situ-formed lithium metal anode on a surface of the current collector facing the separator. In such examples, a battery cell may be configured to lack an anode active material in an uncharged state.

A wide variety of anode materials can be used with the negative electrode, including, without limitation: graphitic carbon (e.g., ordered or disordered carbon with sp2 hybridization, artificial (AG) or natural graphite (NG), or blends thereof), a metal oxide, e.g., lithium titanate, silicon, a silicon-based material (e.g., silicon-based carbon composite, oxide, carbide, a pre-lithiated silicon material), alloy material types, etc. or a combination of any two or more thereof.

The battery cell of the present disclosure further can include a positive electrode that comprises a cathode active material. A wide variety of cathode materials can be used in a battery cell including an electrolyte of the present disclosure. Such cathode active materials can be composed of, without limitation: one or more lithium metal oxides, e.g., a lithium cobalt oxide, a lithium manganese oxide, a lithium nickel manganese cobalt oxide (NMC), lithium nickel cobalt aluminum oxide (NCA), over-lithiated oxides (OLO), which includes an excess stoichiometric mole amount of lithium in a lithium metal oxide, etc., and/or a high-entropy lithium oxide cathode, and/or a lithium metal phosphate, such as a lithium iron phosphate, lithium manganese phosphate, lithium manganese iron phosphate, etc., lithium spinel, or any combinations thereof. In some aspects, the OLO active material has a formula of: Li_{1+y}M_{1-y}O₂, where 0<y≤0.4 and M is a transition metal such as Ni and/or Mn, which may be doped with Al. In other aspects, the OLO active material has less than about 7 wt % cobalt, such as less than 2 wt % cobalt. In another aspect, the cathode can include a nickel-rich oxide having from about 60 mol % to about 98 mol % of nickel.

In an implementation, an electrolyte can be included in a battery cell having the cathode and anode provided in Table 1 below with the following approximate improved performance.

TABLE 1
Example cathode and anode materials.

| Cathode | Anode | Performance |
|---|---|---|
| LFP | SiOx/SiOx-graphite blend | High temperature stability |
| NMC | Si/Si-graphite blend | High voltage stability |
| (Ni: 60-98%) | | |
| LMFP | Sn/Sn-graphite blend | Active material blends |
| OLO | SiOx-Si-graphite | Low gassing at high voltage |
| (Li > 1.05) | | activation or cell storage |
| LNMO | Artificial (AG)/Natural | Transition metal (TM) |
| | Graphite (NG) Blend | dissolution reduction |
| LMFP-NMC | Blend anode materials | Extended temperature window |
| blend | | |

Advantageously, electrolytes of the present disclosure can be used with dense electrodes. For example, the cathode can have an areal loading equal to or higher than 12 mg/cm² and a press density equal to or higher than 2.0 g/cc. An anode can have an areal loading equal to or higher than 4.8 mg/cm² and a press density equal to or higher than 1.4 g/cc for the anode

In accordance with aspects of the subject technology, a method is provided that includes: obtaining a battery having a cell (e.g., a battery cell 120), the cell including a cathode (e.g., cathode 212), an anode (e.g., anode 208), a separator (e.g., separator 220) and an electrolyte of the present disclosure (e.g., electrolyte 210), and operating the cell by charging the cell of the battery, and/or discharging the cell of the battery. Discharging the battery cell can provide electrical power to a power-consuming component (e.g., a vehicle and/or an electrical system of a building).

As provided in the Examples below, a lithium ion battery including an electrolyte of the present disclosure can be configured to have a salt decomposition voltage of at least about 2.45 V.

### EXAMPLES

The following examples are intended to further illustrate certain aspects of the subject technology and are not limiting in nature. Those skilled in the art will recognize, or be able to ascertain, using no more than routine experimentation, numerous equivalents to the specific substances and procedures described herein.

### Example 1

Electrolytes can be prepared within the ranges and components provided in Tables 2A and 2B below.

TABLE 2A
Exemplary electrolytes with lithium salts and solvents

| | LiPF₆ | LiFSI | | | | |
|---|---|---|---|---|---|---|
| Sample | (M) | (M) | EC | DEC | EMC | DMC |
| S1 | 1.1 | 0.1-0.5 | 22-29 | | 33-40 | 33-40 |
| S2 | 1.1 | 0.1-0.5 | 15-23 | | 42-50 | 30-38 |
| S3 | 1.1 | 0.1-0.5 | 15-23 | | 10-20 | 54-64 |

The listed lithium salts are in Molar amounts. The listed solvents are in a parts per volume based on a total volume of the solvents, in which EC represents ethylene carbonate, DEC represents diethyl carbonate, EMC represents ethyl methyl carbonate, and DMC represents dimethyl carbonate.

TABLE 2B
Exemplary electrolytes from Table 2A listing additives.

| | | | | | | | | | | |
|---|---|---|---|---|---|---|---|---|---|---|
| | LiPF6 | LiFSI | | | | | | | | |
| Sample | (M) | (M) | FEC | VC | LFO | BS | PS | SN | ES | HTCN |

| | | | | | | | | |
|---|---|---|---|---|---|---|---|---|
| S1 | 1.1 | 0.1-0.5 | 2 | 1-2 | 0.1-1 | | | |
| S2 | 1.1 | 0.1-0.5 | 1-3 | 1 | 0.1-0.75 | 0.2-1 | | |
| S3 | 1.1 | 0.1-0.5 | 1-2 | 0.5-2 | | 0.5-1 | 0.2-1 | 0.2-1 |

Additives are in weight percent based on the total weight of the electrolyte in which FEC represents fluoroethylene carbonate, VC represents vinylene carbonate, LFO represents lithium difluorophosphate, BS represents butane sultone, PS represents 1,3-propane sultone, SN represents succinonitrile, ES represents ethylene sulfite, HTCN represents hexane tricarbonitrile.

Sample electrolytes were prepared with the components provided in Tables 3A and 3B below.

TABLE 3A
Samples with lithium salts and solvents

| | LiPF₆ | LiFSI | | | | |
|---|---|---|---|---|---|---|
| Sample | (M) | (M) | EC | DEC | EMC | DMC |
| C1 | 1 | | 1 | 1 | | 2 |
| R1 | 1.1 | 0.1 | 28 | | 37 | 35 |
| R2 | 1.1 | 0.1 | 20 | | 45 | 35 |
| C2 | 1.25 | | 20 | | 8 | 72 |
| R3 | 1.1 | 0.15 | 20 | | 18 | 62 |

The listed lithium salts are in Molar amounts. The listed solvents are in a parts per volume based on a total volume of the solvents, in which EC represents ethylene carbonate, DEC represents diethyl carbonate, EMC represents ethyl methyl carbonate, and DMC represents dimethyl carbonate. Electrolytes C1 and C2 are used as comparisons.

TABLE 3B
Samples from Table 3A listing additives.

| | LiPF6 | LiFSI | | | | | | | | |
|---|---|---|---|---|---|---|---|---|---|---|
| Sample | (M) | (M) | FEC | VC | LFO | BS | PS | SN | ES | HTCN |
| C1 | 1 | | | 2 | | | | | | |
| R1 | 1.1 | 0.1 | 2 | 1.5 | 0.75 | | | | | |
| R2 | 1.1 | 0.1 | 1.5 | 1 | 0.5 | 0.5 | | | | |
| C2 | 1.25 | | 1 | 0.5 | | | 1 | 0.75 | | |
| R3 | 1.1 | 0.15 | 1 | 0.75 | | 0.5 | | | 0.5 | 0.5 |

Additives are in weight percent based on the total weight of the electrolyte in which FEC represents fluoroethylene carbonate, VC represents vinylene carbonate, LFO represents lithium difluorophosphate, BS represents butane sultone, PS represents 1,3-propane sultone, SN represents succinonitrile, ES represents ethylene sulfite, HTCN represents hexane tricarbonitrile.

The electrolytes in Table 3A-3B were included in pouch cells with a Ni 94 cathode and Ag:Ng:SiOx anode and tested for performances. Each cathode and anode materials are prepared into the electrodes (cathode and anode) by mixing with carbon and binder. After calendaring, electrode stamping, and tab welding, the pouch cell is built with cathode, anode and separator. Prepared electrolyte is injected to the pouch cell and sealed for the test. After cell fabrication, the cells are loaded into a cell fixture to be cycled under pressure. Initial electrochemical tests include cell activation, i.e., formation, then cells can undergo electrochemical testing. Each electrochemical test is performed at the cycler and all the cells are placed in the temperature-controlled chamber during the tests.

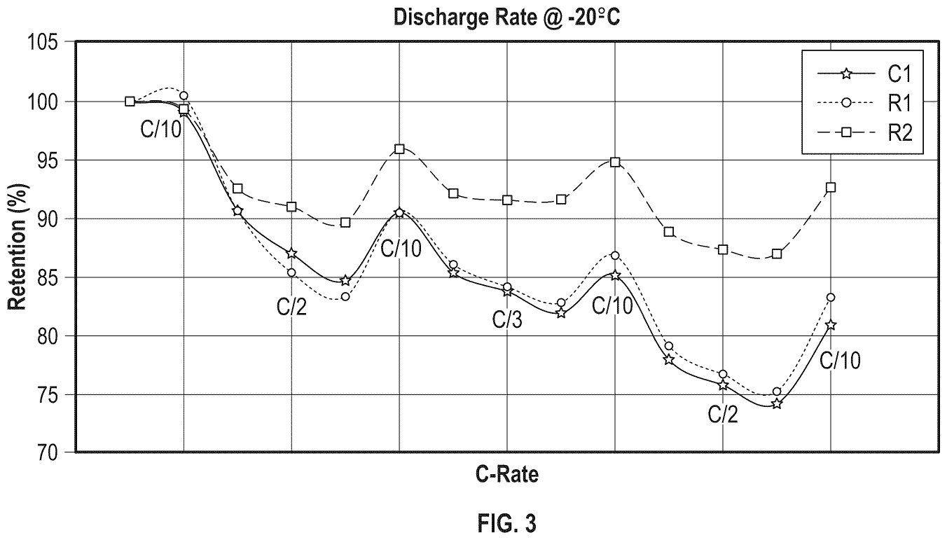

FIG. 3 illustrates a chart of Retention (%) vs C-rates (current rates, C/10, C/3, C/2) at a temperature of −20° C. As illustrated, sample R 2, which had a EC to low temperature solvent ratio of 1:4 and the presence of LiFSI with BS, performed the best at low temperature cycling at −20° C.

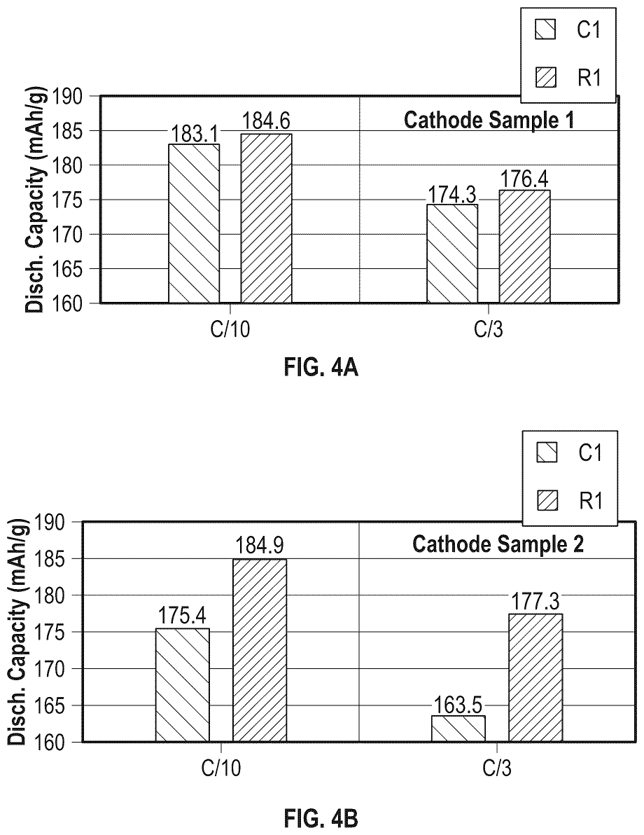

FIGS. 4A and 4B illustrate charts of Discharge Capacity at various discharge rates at a temperature of 0° C. comparing sample C1 to R1. As illustrated, sample R1, which had a EC to low temperature solvent ratio of 1:2.57 and LiFSI to improve temperature and cathode stability. This data shows sample R1 has improved performance, especially for cathode sample 2 which has lower cobalt percentage than cathode sample 1, at different rates (about 5.3% to about 8.5%). Electrolyte R1 improves the low temperature performance of low cobalt and higher manganese cathodes which allows for more capacity to be extracted as demonstrated.

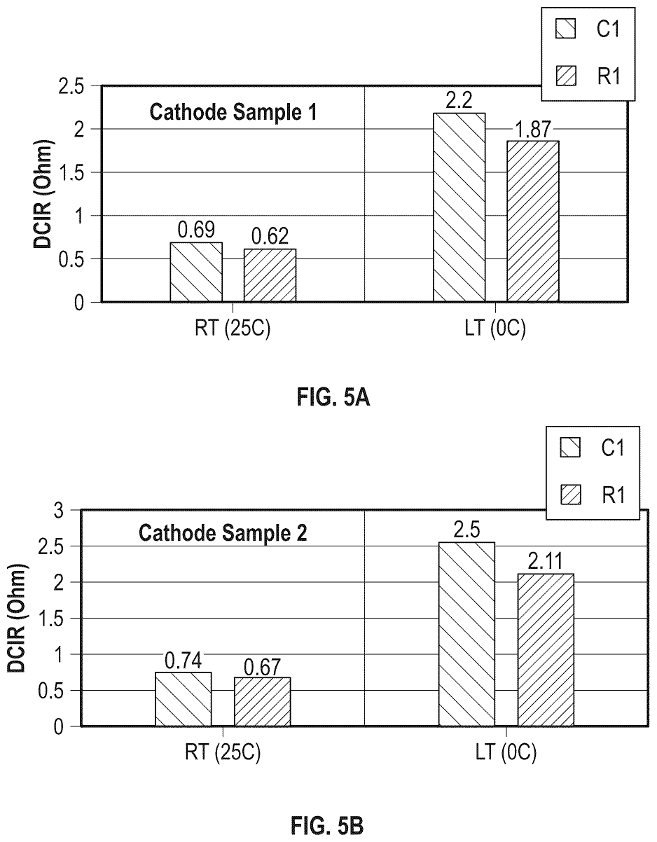

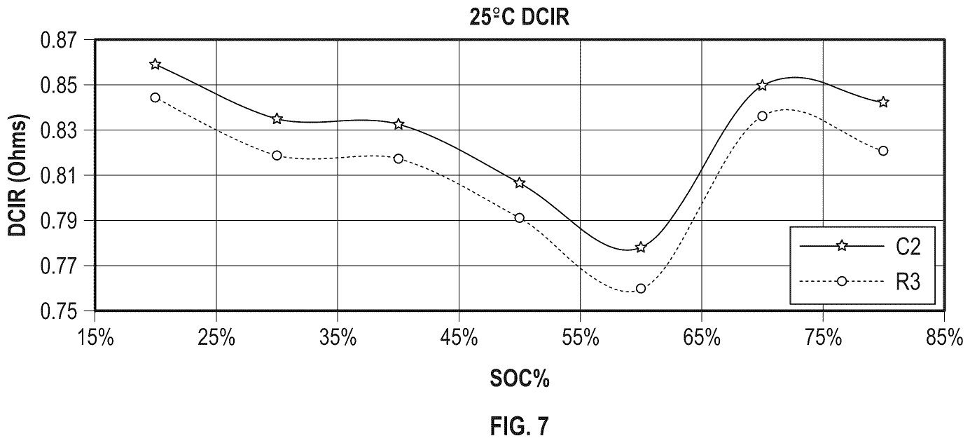

FIGS. 5A and 5B illustrate charts of Direct Current Internal Resistance (DCIR) at various temperatures comparing sample C1 to R1. Direct Current Internal Resistance is the resistance in charge/discharge to a current demand across the terminals of the cell. This data shows sample R1 has improved performance (about 14% to about 16.6%) at lower temperatures compared to the reference cell. Sample R1 improves the DCIR of low cobalt percentage cathodes which would have higher DCIR with nontailored electrolyte formulations as seen in C1 electrolyte to R1 electrolyte. FIG. 7 also illustrates a chart of Direct Current Internal Resistance (DCIR) at various state of charge (SOC) states of a battery cell comparing electrolyte samples C2 and R3. The data in shown Sample R3 has lower DCIR, which is an improvement over comparison electrolyte C1. In particular, an electrolyte of the present disclosure can promote inorganic rich SEI to assist in performance enhancements at a wide temperature window.

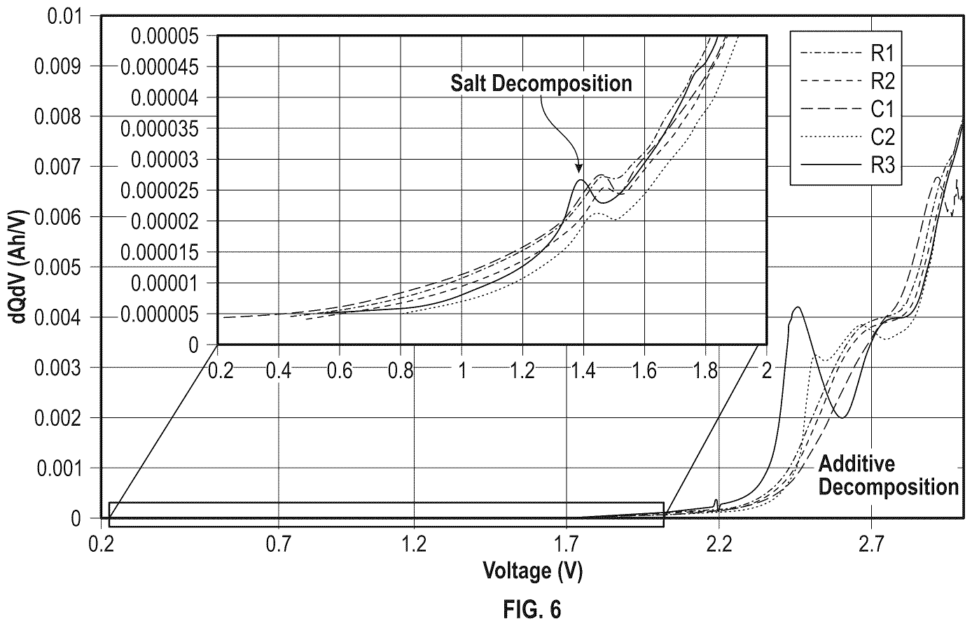

FIG. 6 illustrates a chart showing when the electrolyte tests in the various samples have some decomposition of their components. As shown by the data, R3 has the earliest initial decomposition voltage at around 1.38 (e.g. less than 1.4 V) and a second decomposition voltage at around 2.45V. The decomposition products of the lithium salt, organic electrolyte, and additive molecules contribute to the formation of solid electrolyte interphases (SEIs) on the electrode surface, which have key impacts on the battery's electrochemical performance. In particular, early salt decomposition of an electrolyte of the present disclosure facilitates passivation of the anion with more inorganic species that are anion dependent.

Aspects of the subject technology can help improve the operation and implementation of battery cells. For example, battery cells having an electrolyte of the present disclosure can improve the stability of high energy battery cells such as lithium metal batteries and increase utilization of such batteries. Batteries with increased energy density can help to mitigate climate change by reducing and/or preventing additional greenhouse gas emissions.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, the term “coupled” or the like may refer to being directly coupled. In another aspect, the term “coupled” or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it may be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. An electrolyte, comprising:
(i) a lithium salt; and
(ii) a low temperature solvent combination in a ratio of from about 1:1.25 to about 1:4 of: (a) ethylene carbonate to (b) a low temperature solvent selected from dimethyl carbonate (DMC), ethyl methyl carbonate (EMC), methyl acetate (MA), ethyl propionate (EP), or a combination thereof.

2. The electrolyte of claim 1, wherein the lithium salt includes LiPF₆ in an amount of from about 1 Molar (M) to about 3 M and lithium bis(fluorosulfonyl)imide (LiFSI) in an amount of from about 0.1 M to about 1 M.

3. An electrolyte, comprising:
(i) a lithium salt including lithium bis(fluorosulfonyl)imide (LiFSI) in an amount of from about 1 Molar (M) to about 1.3 M;
(ii) a solvent; and
(iii) an additive of butane sultone (BS) in an amount from about 0.1 wt % to about 1 wt % based on a total weight of the electrolyte.

4. The electrolyte of claim 3, wherein the electrolyte further comprises a low temperature solvent combination in a ratio of from about 1:2.5 to about 1:4 of: (a) ethylene carbonate to (b) a low temperature solvent selected from dimethyl carbonate (DMC), ethyl methyl carbonate (EMC), methyl acetate (MA), ethyl propionate (EP), or a combination thereof.

5. The electrolyte of claim 3, wherein the electrolyte further comprises lithium hexafluorophosphate (LiPF₆).

6. The electrolyte of claim 3, wherein the electrolyte further comprises an additive of ethylene sulfite (ES), hexane tricarbonitrile (HTCN), fluoroethylene carbonate (FEC), vinylene carbonate (VC), or a combination of two or more thereof.

7. The electrolyte of claim 3, wherein the electrolyte further comprises an additive of ethylene sulfite (ES), hexane tricarbonitrile (HTCN), fluoroethylene carbonate (FEC), vinylene carbonate (VC), or a combination of two or more thereof; and wherein the electrolyte includes the additive in an amount of from about 1 wt % to about 4 wt % based on a total weight of the electrolyte.

8. The electrolyte of claim 3, wherein the electrolyte further comprises additives of ethylene sulfite (ES), hexane tricarbonitrile (HTCN), fluoroethylene carbonate (FEC), and vinylene carbonate (VC); and wherein the electrolyte includes each additive independently in an amount of from about 0.1 wt % to about 3 wt % based on a total weight of the electrolyte.

9. The electrolyte of claim 3, wherein the electrolyte excludes 1,3-propane sultone (PS), or prop-1-ene-1,3-sultone (PES).

10. The electrolyte of claim 3, wherein the electrolyte includes an additional additive selected from lithium difluorophosphate (LiPO₂F₂)(LFO).

11. The electrolyte of claim 3, wherein the solvent further comprises ethyl methyl carbonate (EMC), diethyl carbonate (DEC), or a combination thereof as an additional solvent.

12. A battery cell, comprising:
a cathode; an anode; and an electrolyte that comprises Formulation A or Formulation B, wherein:
Formulation A comprises:
(i) a lithium salt;
(ii) a low temperature solvent in a ratio of from about 1:3 to about 1:3.6 of (a) ethylene carbonate to (b) a low temperature solvent selected from dimethyl carbonate (DMC), ethyl methyl carbonate (EMC), methyl acetate (MA), ethyl propionate (EP), or a combination of two or more thereof; and
Formulation B comprises:
(i) a lithium salt including lithium bis(fluorosulfonyl)imide (LiFSI) in an amount of from about 1 Molar (M) to about 1.3 M;
(ii) a solvent; and
(iii) an additive of butane sultone (BS) in an amount from about 0.1 wt % to about 1 wt % based on a total weight of the electrolyte.

13. The battery cell of claim 12, wherein the cathode comprises a nickel-rich oxide having from about 60 mol % to about 98 mol % of nickel.

14. The battery cell of claim 12, wherein the cathode comprises a lithium metal phosphate, a NMC, OLO, or a blend of two or more thereof.

15. The battery cell of claim 12, wherein the anode comprises graphite, silicon, silicon oxide, or a blend thereof.

16. The battery cell of claim 12, wherein the lithium salt decomposes at least in part at 1.4 V or less.

17. The battery cell of claim 12, wherein the cathode has an areal loading of no less than about 12 mg/cm² and a press density of no less than about 2.0 g/cc; and the anode has an areal loading of no less than about 4.8 mg/cm² and a press density of no less than about 1.4 g/cc.

18. The battery cell of claim 12, wherein the electrolyte further comprises an additive of ethylene sulfite (ES), hexane tricarbonitrile (HTCN), fluoroethylene carbonate (FEC), vinylene carbonate (VC), or a combination of two or more thereof.

19. The battery cell of claim 12, wherein the electrolyte further comprises additives of ethylene sulfite (ES), and hexane tricarbonitrile (HTCN) fluoroethylene carbonate (FEC), and vinylene carbonate (VC); and wherein the electrolyte includes each additive independently in an amount of from about 0.1 wt % to about 3 wt % based on a total weight of the electrolyte.

20. A vehicle comprising the battery cell of claim 12.
